(19) United States
(12) Patent Application Publication
(10) Pub. No.: US 2023/0163436 A1
(43) Pub. Date: May 25, 2023

(54) ELECTRONIC DEVICE

(71) Applicant: SONY GROUP CORPORATION, TOKYO (JP)

(72) Inventors: HIDETOSHI AKASAWA, TOKYO (JP); TATSUYA FURUYA, TOKYO (JP)

(21) Appl. No.: 17/917,173

(22) PCT Filed: Apr. 20, 2020
(86) PCT No.: PCT/JP2020/017094

§ 371 Date: Oct. 5, 2022

(51) Int. Cl. H01M 50/595; H01M 50/202; H01M 50/247

(52) U.S. Cl. CPC H01M 50/595; H01M 50/202; H01M 50/247

(57) ABSTRACT

An electronic device (1) includes: a battery pack (10) that includes a battery cell housed inside an exterior member (30) so that a battery element (20) is movable in a movable direction (M); a housing (40) that houses the battery pack (10); and adhesive members (50) that bond the battery pack (10) inside the housing (40), in which the adhesive members (50) bond the battery pack (10) and the housing (40) on a second line (L2) where an angle formed with a first line (L1) parallel to the movable direction (M) is an acute angle and that passes through a center (10S) of the battery pack (10).

### FIELD

The present disclosure relates to an electronic device including a battery pack.

### BACKGROUND

Conventionally, an electronic device such as a smartphone incorporates a secondary battery represented by a lithium ion battery. For example, Patent Literature 1 discloses a battery cell in which a battery element is housed in an exterior material made of a laminate film, a resin layer is inserted into one or more surfaces of the battery element, and the battery element and the exterior material are separated from each other. For example, Patent Literature 2 discloses a battery pack including a battery cell including a battery element, at least one holder provided to face an end of the battery element, and an impact-absorbing structure formed in the holder.

### CITATION LIST

### Patent Literature

Patent Literature 1: JP 2000-173641 A

Patent Literature 2: JP 2019-186016 A

### SUMMARY

### Technical Problem

In the above-described conventional technique, in an electronic device incorporating a battery pack, there is a possibility that the battery element itself is damaged by movement of the battery element inside the battery cell due to an impact such as dropping.

Therefore, the present disclosure proposes an electronic device capable of suppressing damage when a battery pack in which a battery element is movable is dropped.

### Solution to Problem

To solve the problems described above, an electronic device according to an embodiment of the present disclosure includes: a battery pack that includes a battery cell housed inside an exterior member so that a battery element is movable in a movable direction; a housing that houses the battery pack; and adhesive members that bond the battery pack inside the housing, wherein the adhesive members bond the battery pack and the housing on a second line where an angle formed with a first line parallel to the movable direction is an acute angle and that passes through a center of the battery pack.

### BRIEF DESCRIPTION OF DRAWINGS

FIG. 1 is a perspective diagram illustrating an appearance of a battery pack according to an embodiment.

FIG. 2 is an exploded perspective diagram of a battery pack according to an embodiment.

FIG. 3 is a diagram for illustrating a configuration example of a battery element configuring a battery cell according to an embodiment.

FIG. 4 is a schematic diagram illustrating an internal structure of an electronic device according to an embodiment.

FIG. 5 is a diagram illustrating a relationship between a battery pack and an adhesive member in an electronic device according to an embodiment.

FIG. 6 is a diagram for illustrating a principle of suppressing a drop impact energy in an electronic device according to an embodiment.

FIG. 7A is a diagram illustrating a fixing structure of a battery pack according to a comparative example.

FIG. 7B is a diagram illustrating a fixing structure of a battery pack according to a comparative example.

FIG. 7C is a diagram illustrating a fixing structure of a battery pack according to a comparative example.

FIG. 7D is a diagram illustrating a fixing structure of a battery pack according to a comparative example.

FIG. 8 is a diagram for illustrating a drop experiment method using a battery pack.

FIG. 9 is a diagram illustrating an experimental result when a battery pack fixed with a fixing structure of a comparative example is dropped.

FIG. 10 is a diagram illustrating an experimental result when a battery pack fixed with a fixing structure according to an embodiment is dropped.

FIG. 11 is a diagram illustrating a relationship between a battery pack and an adhesive member in an electronic device according to modification (1) of an embodiment.

FIG. 12 is a diagram illustrating a relationship between a battery pack and an adhesive member in an electronic device according to modification (2) of an embodiment.

FIG. 13 is an exploded perspective diagram illustrating another example of a battery pack according to an embodiment.

### DESCRIPTION OF EMBODIMENTS

Hereinafter, an embodiment of the present disclosure will be described in detail with reference to the drawings. In each of the following embodiments, the same parts are denoted by the same reference numerals, and redundant description will be omitted.

A battery pack included in an electronic device according to the present embodiment includes, for example, a built-in battery pack that is not removable by a user. In the present embodiment, a structure including a battery element before the battery element is covered with a laminated sheet is referred to as a battery cell, and a structure in which a circuit board is coupled to the battery cell and a laminate sheet, a top holder, and a bottom holder are attached is referred to as a battery pack. In the battery pack and the battery cell, a lead-out side of a positive electrode terminal and a negative electrode terminal is referred to as a top portion, a side facing the top portion is referred to as a bottom portion, and the other sides are referred to as side portions. Furthermore, a length in a direction of both side portions may be referred to as a width, and a length in a direction of the top portion and the bottom portion may be referred to as a height.

### Embodiment

### Basic Configuration Example of Battery Pack According to Embodiment

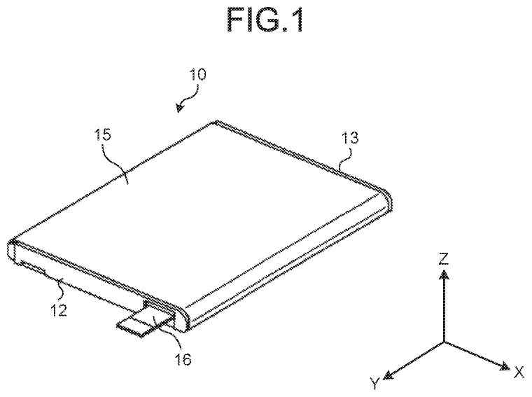

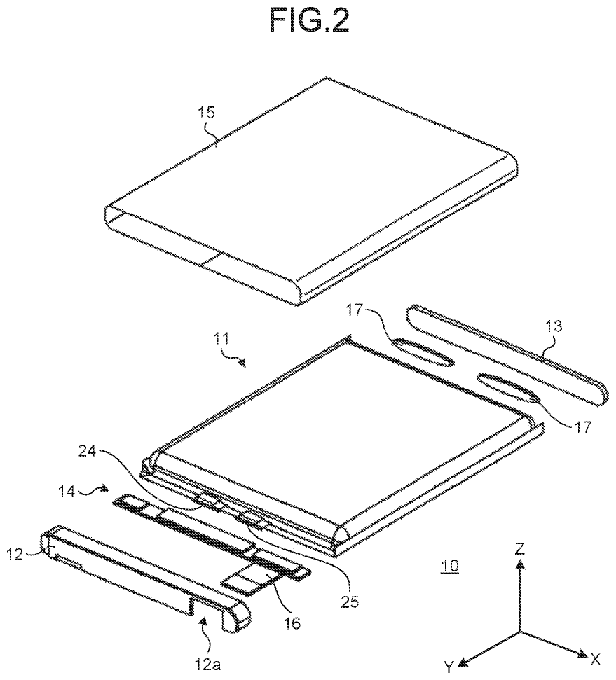

An example of a basic configuration of a battery pack according to an embodiment will be described. FIG. 1 is a perspective diagram illustrating an appearance of the battery pack according to the embodiment. FIG. 2 is an exploded perspective diagram of the battery pack according to the embodiment. Hereinafter, in the drawings, an X axis indicates a width direction of the battery pack, a Y axis indicates a longitudinal direction of the battery pack, and a Z axis indicates a thickness direction of the battery pack, respectively.

A battery pack 10 illustrated in FIGS. 1 and 2 is, for example, a battery pack of an angular or flat type lithium ion secondary battery. The battery pack 10 is mounted on a portable electronic device. In the present embodiment, the electronic device is configured so that the user cannot attach or detach the battery pack 10.

Examples of the electronic device include, but are not limited to, a smartphone, a tablet computer, a notebook personal computer, a personal digital assistant (PDA), a portable game device, a display device, an electronic book, a music player, a navigation system, a machine tool, and the like.

As illustrated in FIG. 2, the battery pack 10 includes a battery cell 11, a top holder 12, a bottom holder 13, a circuit board 14, and a laminate sheet 15.

The battery cell 11 includes, for example, a battery element electrically coupled to a circuit board covered with a laminate film of soft aluminum or the like. The laminate sheet 15 is attached to an outer periphery of the battery cell 11. The battery cell 11 includes a battery element having a positive electrode terminal 24 and a negative electrode terminal 25. The positive electrode terminal 24 and the negative electrode terminal 25 are covered with an insulating sheet (not illustrated) except for a coupling portion with the circuit board 14.

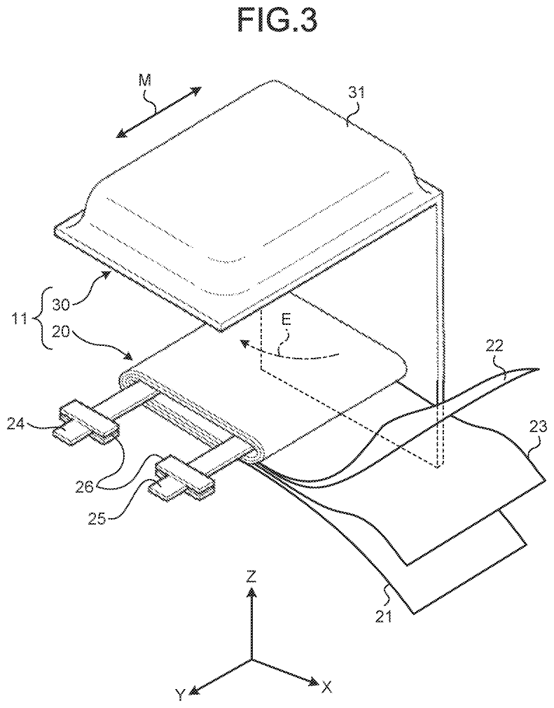

FIG. 3 is a diagram for illustrating a configuration example of the battery element configuring the battery cell 11 according to the embodiment. As illustrated in FIG. 3, the battery cell 11 includes a battery element 20 and an exterior member 30.

The battery element 20 is a secondary battery of a laminate film type. The battery element 20 includes, for example, a wound electrode body. The battery element 20 is housed in a film-like exterior member 30. Note that FIG. 3 illustrates a state of the battery element 20 before the battery element 20 is completely wound and a state of the exterior member 30 before the battery element 20 is housed inside, in order to make the configurations of the battery element 20 and the exterior member 30 easily viewable.

In the battery element 20, for example, a positive electrode 21 and a negative electrode 22 are laminated with a separator 23 interposed therebetween, and the positive electrode 21 and the negative electrode 22 laminated with the separator 23 interposed therebetween are wound. The battery element 20 is impregnated with an electrolytic solution which is a liquid electrolyte. That is, the battery element 20 includes an electrolytic solution together with the positive electrode 21, the negative electrode 22, and the separator 23. The positive electrode terminal 24 is attached to the positive electrode 21. The negative electrode terminal 25 is attached to the negative electrode 22. The outer peripheral portion of the battery element 20 is protected by, for example, a protective tape. The positive electrode terminal 24 and the negative electrode terminal 25 are led out from an inside to an outside of the exterior member 30, for example. The positive electrode terminal 24 and the negative electrode terminal 25 are formed in a thin plate shape or a mesh shape by a conductive material.

The exterior member 30 is, for example, one sheet of film that can be folded in a direction of an arrow E indicated in FIG. 3. For example, a recess 31 for accommodating the battery element 20 is provided in a part of the exterior member 30. The exterior member 30 is, for example, a laminate film or the like. The laminate film has, for example, a configuration such as a fusion layer, a metal layer, and a surface protective layer.

For example, in the exterior member 30, the fusion layers are folded so as to face each other with the battery element 20 interposed therebetween, and then portions around the recess 31 in which the battery element 20 is accommodated are fused to each other, whereby the exterior member 30 is sealed in a state where the battery element 20 is housed in the recess 31. The fusion layers of the exterior member 30 may be bonded to each other with an adhesive or the like interposed therebetween.

The exterior member 30 accommodates the battery element 20 in the recess 31 so that the battery element 20 is movable in a movable direction M (Y-axis direction) along an extending direction of the positive electrode terminal 24 and the negative electrode terminal 25 inside the recess 31. That is, the recess 31 is formed in a size that enables movement of the housed battery element 20 in the movable direction M and does not allow movement of the battery pack 10 in the width direction (X-axis direction). The movable direction M is a direction in which the positive electrode terminal 24 and the negative electrode terminal 25 of the battery pack 10 are led out from the battery cell 11. Between the exterior member 30 and the positive electrode terminal 24 and the negative electrode terminal 25, for example, an adhesive film 26 for preventing outside air from entering the inside of the exterior member 30 is provided.

Returning to FIG. 2, the circuit board 14 is disposed on the top portion of the plate-shaped battery cell 11, and is electrically coupled to the positive electrode terminal 24 and the negative electrode terminal 25 of the battery element 20. The circuit board 14 is coupled to a flexible circuit board 16 coupled to a device body of the electronic device. As the circuit board 14, for example, a coupling member such as a coupling terminal may be used instead of the flexible circuit board 16.

The top holder 12 is attached to an end of the top portion of the battery cell 11. For example, the top holder 12 is wrapped and fixed by the laminate sheet 15 together with the battery cell 11 in a state of being disposed at the end of the top portion of the battery cell 11. The top holder 12 holds the circuit board 14 therein. The top holder 12 has an opening 21a at a position corresponding to the flexible circuit board 16 coupled to the circuit board 14. The flexible circuit board 16 is led out to the outside of the battery pack 10 via an opening 12a.

The bottom holder 13 is attached to an end of a bottom portion of the battery cell 11. For example, the bottom holder 13 is wrapped and fixed by the laminate sheet 15 together with the battery cell 11 in a state of being disposed at the end of the bottom portion of the battery cell 11. The bottom holder 13 is fixed to the battery cell 11 by an adhesive 17.

Note that FIG. 2 illustrates a simplified configuration of the top holder 12 and the bottom holder 13, and the present disclosure is not limited to this configuration.

The laminate sheet 15 has a substantially rectangular shape, and is attached to the battery cell 11 so as to wrap the battery cell 11. The laminate sheet 15 is attached to a periphery of the battery cell 11 via an adhesive. The laminate sheet 15 is a protective sheet for protecting the battery cell 11, and may have higher strength than a resin laminate sheet. Thus, the battery pack 10 can protect the battery cell 11 from an external impact. The laminate sheet 15 may be, for example, a laminate in which an electrically insulating resin layer is laminated on both surfaces of a hard aluminum layer.

The configuration example of the battery pack 10 according to the embodiment has been described above. Note that the above-described configuration described with reference to FIGS. 1 to 3 is merely an example, and the configuration of the battery pack 10 according to the present embodiment is not limited to such an example. The functional configuration of the battery pack 10 according to the present embodiment can be flexibly modified according to specifications and operations. The battery pack may have a configuration in which the battery element is housed inside the exterior member so as to be movable in the movable direction M. The battery pack may include, for example, a configuration in which the battery element is attached to the exterior member with a tape or a label. In addition, the movable direction M may include, for example, an assumed drop direction in the electronic device, a direction set in advance based on a disposition relationship between the battery pack and a board coupled to the battery pack, and the like.

### Problems of Battery Pack

The battery pack 10 is fixed inside the electronic device by, for example, a double-sided tape, an adhesive, or the like. However, in the battery pack 10, the battery element 20 is not fixed to the recess 31 of the exterior member 30 inside the battery cell 11. Therefore, in a case where the electronic device is dropped, or the like, in the battery pack 10, the battery element 20 may move in the movable direction M due to the impact. For example, in the battery pack 10, when the battery element 20 moves, the positive electrode terminal 24 and the negative electrode terminal 25 may be broken, or the battery element 20 itself may be damaged. The present embodiment provides an electronic device in which the battery element 20 is movable thereby suppressing damage when the battery pack 10 is dropped.

### Configuration Example of Electronic Device According to Embodiment

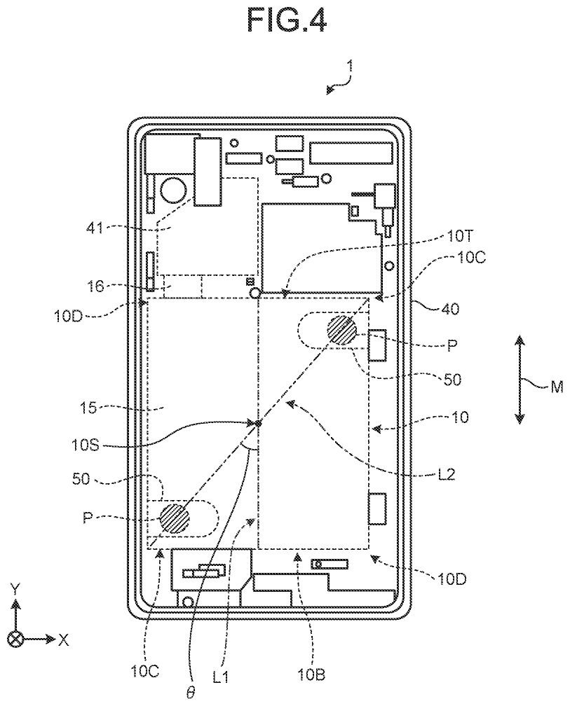

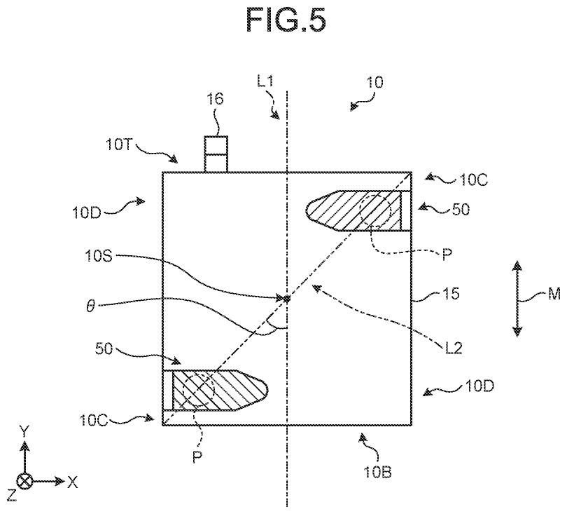

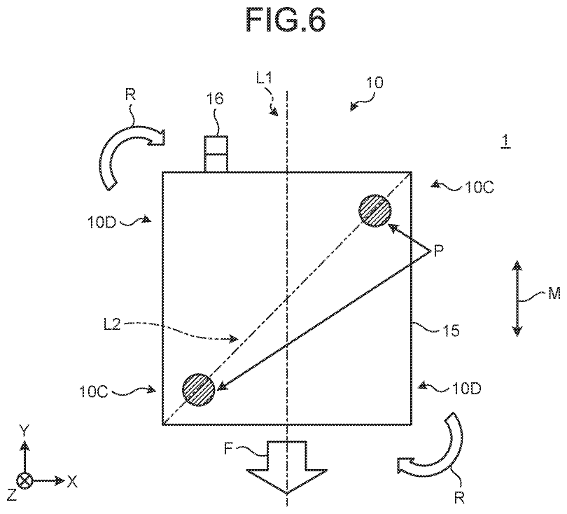

FIG. 4 is a schematic diagram illustrating an internal structure of the electronic device according to the embodiment. FIG. 4 illustrates a state in which a back surface cover of the electronic device is seen through. FIG. 4 illustrates only a configuration according to the present disclosure, and omits other configurations. FIG. 5 is a diagram illustrating a relationship between the battery pack and the adhesive member in the electronic device according to the embodiment. FIG. 6 is a diagram for illustrating a principle of suppressing the drop impact energy in the electronic device according to the embodiment.

In the example illustrated in FIG. 4, an electronic device 1 is a smartphone. The electronic device 1 includes the battery pack 10, a housing 40, and adhesive members 50.

The electronic device 1 is housed inside the housing 40 so that a direction from a top portion 10T to a bottom portion 10B of the battery pack 10 is along the longitudinal direction (Y-axis direction) of electronic device 1. The housing 40 is formed in a hollow thin plate shape by combining a front cover and a back surface cover, for example. The electronic device 1 houses the flexible circuit board 16, which is a coupling portion of the battery pack 10, in a state of being electrically coupled to a board 41 inside the housing 40. The board 41 is housed inside the housing 40 and includes, for example, a board or the like that controls the electronic device 1.

In the electronic device 1, the battery pack 10 that is positioned at a predetermined position is fixed inside the housing 40 by the adhesive members 50. In the electronic device 1, the battery pack 10 is disposed inside the housing 40 so as to have an interval within a predetermined tolerance range with respect to components around the battery pack 10.

As illustrated in FIGS. 4 and 5, the adhesive members 50 bond the battery pack 10 to the inside of the housing 40. The adhesive members 50 include, for example, a double-sided tape, an adhesive, and the like. The adhesive members 50 fix the battery pack 10 to the housing 40 by bonding a component fixed to an inner surface of the housing 40 or an inside of the housing 40 and the laminate sheet 15 of the battery pack 10.

The adhesive members 50 bond the battery pack 10 and the housing 40 at fixing positions P on a second line L2 at which an angle θ formed with a first line L1 parallel to the movable direction M of the battery element 20 is an acute angle and that passes through a center 10S of the battery pack 10. The fixing positions P are set, for example, to be in vicinities of corner portions 10C that are the diagonals of the battery pack 10. The corner portions 10C according to the present disclosure are centered on a portion where two sides of the battery pack 10 are connected, and include partial regions of surfaces facing the housing 40. The angle θ formed by the first line L1 and the second line L2 is an angle smaller than a right angle, and may be any angle. The center 10S of the battery pack 10 includes, for example, a center of a contact surface of the laminate sheet 15 with the housing 40, a range away from the center by a predetermined distance, or the like. Accordingly, when a slight impact is applied to the electronic device 1, the adhesive members 50 prevent the position of the battery pack 10 from being displaced inside the electronic device 1. That is, the adhesive members 50 have a strength capable of suppressing displacement between the battery pack 10 and the housing 40.

In the examples illustrated in FIGS. 4 and 5, the second line L2 is the diagonal line connecting the two corner portions 10C of the battery pack 10. The adhesive members 50 bond the battery pack 10 and the housing 40 at the fixing positions P of the two corner portions 10C on the second line L2. The fixing positions P of the corner portions 10C may be, for example, positions in the vicinities of the corner portions 10C or positions away from the corner portions 10C. Two corner portions 10D of the battery pack 10 facing the corner portions 10C with the first line L1 interposed therebetween are not provided with the adhesive members 50. That is, in the electronic device 1, the portions of the corner portions 10D of the battery pack 10 are not fixed to the housing 40. In other words, in the battery pack 10, the corner portions (second corner portions) 10D facing the corner portions 10C of the housing 40 to which the adhesive members 50 are bonded with the first line L1 interposed therebetween are not bonded to the housing 40.

The adhesive members 50 are formed in a band shape extending from the corner portions 10C of the battery pack 10 to the vicinity of the first line L1. The adhesive members 50 fix the battery pack 10 and the housing 40 in a range from the fixing positions P of the corner portions 10C of the battery pack 10 to the vicinity of the first line L1. Note that the adhesive members 50 may be realized by one band-shaped adhesive member or may be realized by a plurality of circular adhesive members.

For example, the adhesive members 50 are provided at fixing positions of the battery pack 10, and the battery pack 10 is assembled to the housing 40 to fix the battery pack 10 and the housing 40. The adhesive members 50 may be provided on any one of the battery pack 10 and the housing 40, or may be provided on the housing 40 side.

The configuration example of the electronic device 1 according to the embodiment has been described above. Note that the above-described configuration described with reference to FIG. 4 is merely an example, and the configuration of the electronic device 1 according to the present embodiment is not limited to such an example. The functional configuration of the electronic device 1 according to the present embodiment can be flexibly modified according to specifications and operations.

In the present embodiment, a case where the adhesive members 50 bond the battery pack 10 and the housing 40 at the fixing positions P of the two corner portions 10C in the electronic device 1 will be described, but the present invention is not limited thereto. For example, the electronic device 1 may be configured to provide the adhesive members 50 at one or three or more fixing positions on the second line L2. For example, the electronic device 1 may have a configuration in which a circular adhesive member 50 is provided at one fixing position in the vicinity of the center 10S of the battery pack 10 on the second line L2.

In the present embodiment, in the electronic device 1, a case where the first line L1 and the second line L2 pass through the center 10S of the battery pack 10 has been described, but the present invention is not limited thereto. For example, in the electronic device 1, the first line L1 may not pass through the center of the battery pack 10 as long as the first line L1 is parallel to the movable direction M of the battery element 20.

### Operating Principle of Electronic Device According to Embodiment

FIG. 6 is a diagram for illustrating the principle of the battery pack 10 when an impact energy at the time of dropping is applied to the electronic device 1 according to the embodiment. In FIG. 6, only the battery pack 10 of the electronic device 1 is illustrated, and other configurations are omitted.

In the example illustrated in FIG. 6, the electronic device 1 is dropped onto a ground from the bottom portion 10B side of the battery pack 10 in a drop direction F. In this case, when the impact due to the dropping is applied to the battery pack 10 via the electronic device 1, a moment in the rotation direction R is generated, and the impact energy in the drop direction F can be released in the rotation direction R. That is, in the electronic device 1, since the battery pack 10 and the housing 40 are fixed at the two corner portions 10C on the second line L2 and the battery pack 10 and the housing 40 are not fixed at the two corner portions 10D, it is possible to generate the moment in the rotation direction R around the second line L2. As a result, the electronic device 1 can reduce a movement amount of the battery element 20 inside the battery pack 10 in accordance with the dropping, so that it is possible to suppress damage at the time of the dropping of the battery pack 10 in which the battery element 20 is movable. In addition, even when the battery pack 10 and the housing 40 are fixed at the two corner portions 10C on the second line L2 and the battery pack 10 and the housing 40 are fixed at one of the two corner portions 10D, the electronic device 1 can generate the moment in the rotation direction R around the second line L2.

### Comparison between Fixing Structure of Battery Pack According to Embodiment and Fixing Structure of Comparative Example

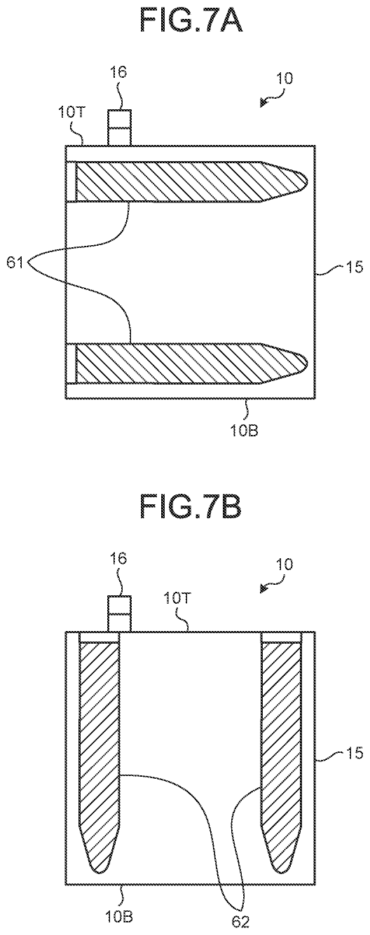

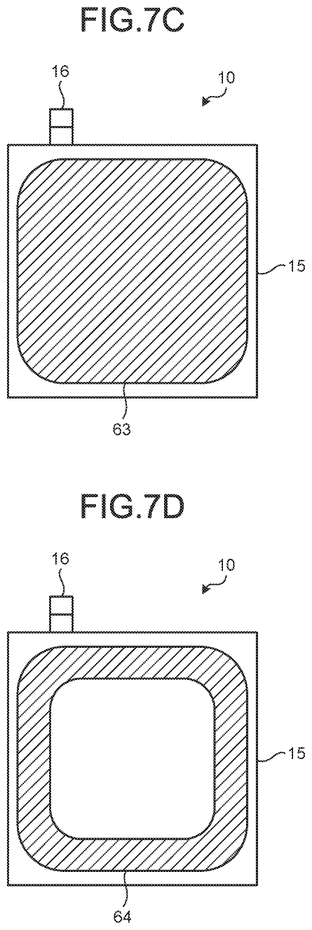

The fixing structure of a comparative example of the battery pack 10 has various fixing structures for the double-sided tape. Each of FIGS. 7A to 7D is a diagram illustrating a fixing structure of the battery pack 10 according to the comparative example. In the fixing structure illustrated in FIG. 7A, the battery pack 10 and the housing 40 are fixed by providing two band-shaped double-sided tapes 61 along respective vicinities of the top portion 10T and the bottom portion 10B of the battery pack 10. In the fixing structure illustrated in FIG. 7B, the battery pack 10 and the housing 40 are fixed by providing two band-shaped double-sided tapes 62 from the top portion 10T to the bottom portion 10B of the battery pack 10 and along the vicinity of each edge of the battery pack 10. The fixing structure illustrated in FIG. 7C fixes the battery pack 10 and the housing 40 by providing a double-sided tape 63 on an entire surface of the laminate sheet 15 of the battery pack 10 facing the housing 40. In the fixing structure illustrated in FIG. 7D, the battery pack 10 and the housing 40 are fixed by providing a double-sided tape 64 having a substantially ring shape on an entire surface of the laminate sheet 15 of the battery pack 10 facing the housing 40.

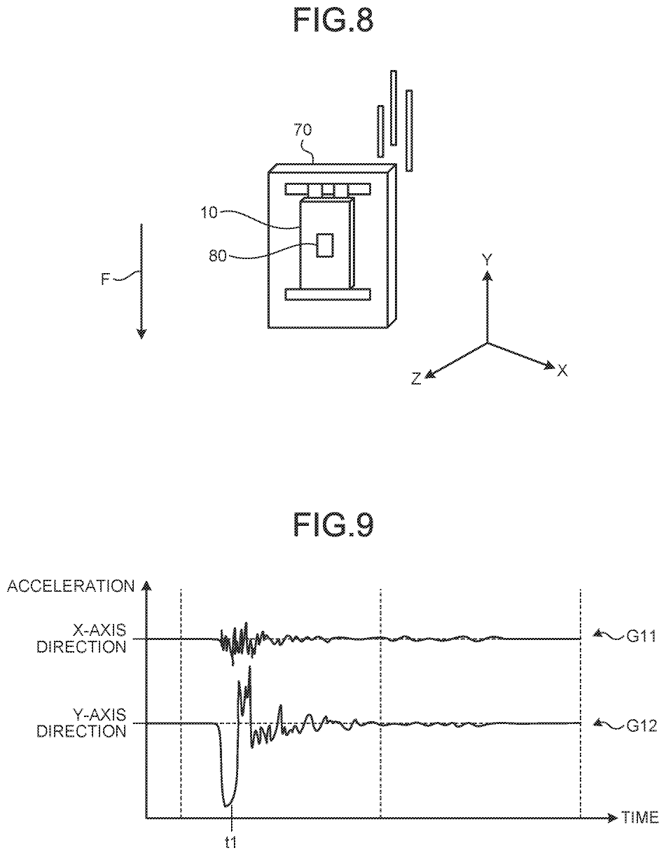

FIG. 8 is a diagram for illustrating a drop experiment method using the battery pack 10. The experimental method illustrated in FIG. 8 illustrates an experimental method in which the battery pack 10 is fixed to an object 70 with a fixing structure of the comparative example or the fixing structure according to the embodiment, an acceleration sensor 80 is attached in the vicinity of the center of the battery pack 10, and the object 70 is dropped in the drop direction F. This experimental method makes it possible to observe the impact energy generated in the battery pack 10 based on a detection result of the acceleration sensor 80. In FIG. 8, the width direction of the battery pack 10 is the X-axis direction, the direction from the top portion 10T to the bottom portion 10B of the battery pack 10 is the Y-axis direction, and the thickness direction of the battery pack 10 is the Z-axis direction.

FIG. 9 is a diagram illustrating an experimental result when the battery pack 10 fixed by the fixing structure of the comparative example is dropped. In FIG. 9, a vertical axis indicates an acceleration in the X-axis direction and the Y-axis direction, and a horizontal axis indicates time. The graph illustrated in FIG. 9 illustrates the experimental result when the battery pack 10 is fixed to the object 70 with the fixing structure illustrated in FIG. 7A and dropped. The graph illustrated in FIG. 9 indicates that the impact due to the dropping is occurred in the battery pack 10 at timet1. In FIG. 9, a graph G11 in the X-axis direction changes around time t1, and a graph G12 in the Y-axis direction changes more greatly than the graph G11. That is, the graph G12 indicates that the impact energy due to the dropping is greatly received with respect to the Y-axis direction of the battery pack 10 fixed by the fixing structure of the comparative example. Note that the experimental results using the fixing methods illustrated in FIGS. 7B, 7C, and 7D are similar to the experimental result illustrated in FIG. 9, and thus are omitted.

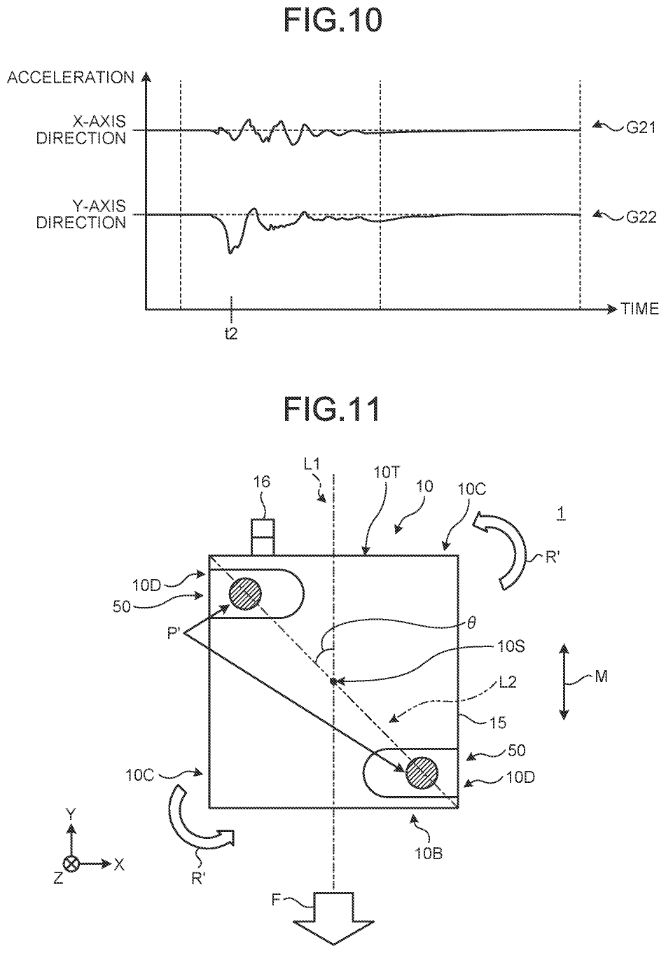

FIG. 10 is a diagram illustrating an experimental result when the battery pack 10 fixed with the fixing structure according to the embodiment is dropped. In FIG. 10, as in FIG. 9, a vertical axis indicates an acceleration in the X-axis direction and the Y-axis direction, and a horizontal axis indicates time. The graph illustrated in FIG. 10 indicates the experimental result when the battery pack 10 is fixed to the object 70 with the fixing structure illustrated in FIGS. 4 and 5 and the object 70 is dropped. The graph illustrated in FIG. 10 indicates that the impact due to the dropping is occurred in the battery pack 10 at time t2. In FIG. 10, a graph G21 in the X-axis direction changes near time t2, but intervals of amplitudes are wider than those of the graph G11 illustrated in FIG. 9, indicating that the impact in the X-axis direction is dispersed. In FIG. 10, the graph G22 in the Y-axis direction changes near time t2, but fluctuation is smaller than that of the graph G12 illustrated in FIG. 9, indicating that the impact energy in the Y-axis direction is suppressed.

As described above, in the electronic device 1 according to the embodiment, the adhesive members 50 bond the battery pack 10 and the housing 40 on the second line L2 at which the angle θ formed with the first line L1 parallel to the movable direction M of the battery pack 10 is an acute angle and that passes through the center 10S of the battery pack 10. As a result, when the electronic device 1 is dropped in the drop direction F along the movable direction M, the impact energy can be suppressed in the battery pack 10 more than that in the fixing structure of the comparative example. On the other hand, when the fixing structure of the comparative example is used, in the battery pack 10, since the four corner portions 10C and 10D are fixed with the same adhesive strength, the impact energy due to the dropping cannot be released. As a result, the electronic device 1 having the fixing structure according to the embodiment can reduce a movement amount of the battery element 20 inside the battery pack 10 in accordance with the dropping, so that it is possible to suppress damage at the time of the dropping of the battery pack 10 in which the battery element 20 is movable.

### Modification (1) of Embodiment

In the electronic device 1 according to the above embodiment, the fixing positions P fixed by the adhesive members 50 can be changed.

FIG. 11 is a diagram illustrating a relationship between the battery pack 10 and the adhesive members 50 in electronic device 1 according to modification (1) of the embodiment. As illustrated in FIG. 11, the adhesive members 50 bond the battery pack 10 and the housing 40 at fixing positions P′ on the second line L2 at which an angle formed with a first line parallel to the movable direction M of the battery element 20 is an acute angle and that passes through the center 10S of the battery pack 10. The fixing positions P′ are set, for example, so that the flexible circuit board 16 is led out to the outside and is in the vicinities of the corner portions 10D that are the diagonals of the battery pack 10. The angle θ formed by the first line L1 and the second line L2 is smaller than a right angle.

In the example illustrated in FIG. 11, the second line L2 is the diagonal line connecting two corner portions 10D of the battery pack 10. The adhesive members 50 bond the battery pack 10 and the housing 40 at the fixing positions P′ of the two corner portions 10D on the second line L2. The fixing positions P′ of the corner portions 10D may be, for example, positions in the vicinities of the corner portions 10D or positions away from the corner portions 10D. Two corner portions 10C of the battery pack 10 facing the corner portions 10D with the first line L1 interposed therebetween are not provided with the adhesive members 50. That is, in the electronic device 1, the portions of the corner portions 10C of the battery pack 10 are not fixed to the housing 40. In the example illustrated in FIG. 11, the corner portions 10C correspond to the second corner portions.

The adhesive members 50 are provided in a band shape extending from the corner portions 10D of the battery pack 10 to the vicinity of the first line L1. The adhesive members 50 fix the battery pack 10 and the housing 40 in a range from the fixing positions P′ of the corner portions 10D of the battery pack 10 to the vicinity of the first line L1. Note that the adhesive members 50 may be realized by one band-shaped adhesive member or may be realized by interspersing a plurality of circular adhesive members.

In the electronic device 1 according to the modification (1) of the embodiment, in a case where the electronic device 1 is dropped onto the ground from the bottom portion 10B side of the battery pack 10 in the drop direction F, when the impact due to the dropping is applied to the battery pack 10, a moment in a rotation direction R′ is generated, and the impact energy in the drop direction F can be released in the rotation direction R′. That is, in the electronic device 1, since the battery pack 10 and the housing 40 are fixed at the two corner portions 10D on the second line L2 and the battery pack 10 and the housing 40 are not fixed at the two corner portions 10C, the moment in the rotation direction R′ is generated around the second line L2. As a result, the electronic device 1 can reduce a movement amount of the battery element 20 inside the battery pack 10 in accordance with the dropping, so that it is possible to suppress damage at the time of the dropping of the battery pack 10 in which the battery element 20 is movable, similarly to the embodiment.

### Modification (2) of Embodiment

In the electronic device 1 according to the embodiment, fixing positions to be fixed by the adhesive members 50 can be added.

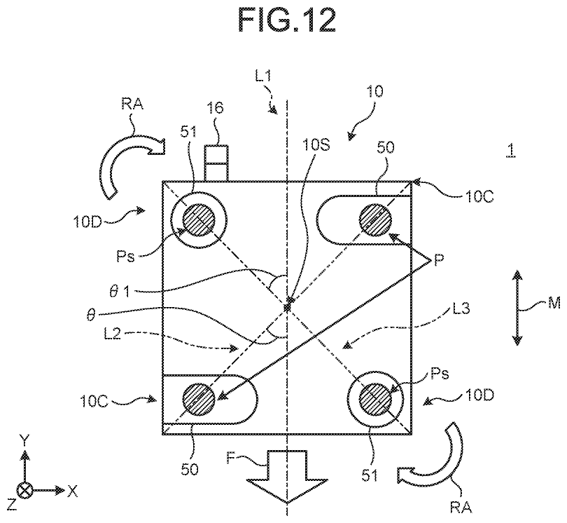

FIG. 12 is a diagram illustrating a relationship between the battery pack 10 and the adhesive members 50 in electronic device 1 according to modification (2) of the embodiment. As illustrated in FIG. 12, the adhesive members 50 bond the battery pack 10 and the housing 40 at the fixing positions P on the second line L2 at which an angle θ formed with the first line L1 parallel to the movable direction M of the battery element 20 is an acute angle and that passes through the center 10S of the battery pack 10. The fixing positions P are set, for example, to be in the vicinities of the corner portions 10C that are the diagonals of the battery pack 10. The angle θ formed by the first line L1 and the second line L2 is smaller than a right angle.

The electronic device 1 further includes second adhesive members 51 that bond the battery pack 10 and the housing 40 with a lower adhesive strength than that of the adhesive members 50 at the corner portions 10D of the battery pack 10 facing the corner portions 10C of the battery pack 10 with the first line L1 interposed therebetween. That is, the electronic device 1 according to the modification (2) of the embodiment includes the battery pack 10, the housing 40, the adhesive members 50, and the second adhesive members 51.

In the example illustrated in FIG. 12, the second adhesive members 51 bond the battery pack 10 and the housing 40 at two fixing positions Ps on a third line L3 at which an angle θ1 formed with the first line L1 is an acute angle and that passes through the center 10S of the battery pack 10. For example, the fixing positions Ps are set so as to be in the vicinities of the corner portions 10D which are the diagonals of the battery pack 10. The angle θ1 formed by the first line L1 and the third line L3 is smaller than a right angle. By making the shape of the second adhesive members 51 smaller than that of the adhesive members 50, the adhesive strength between the battery pack 10 and the housing 40 is made smaller than that of the adhesive members 50. As the second adhesive members 51, an adhesive member having lower adhesive strength than the adhesive members 50 may be used.

In the electronic device 1 according to the modification (2) of the embodiment, in a case where the electronic device 1 is dropped onto the ground from the bottom portion 10B side of the battery pack 10 in the drop direction F, when an impact due to the dropping is applied to the battery pack 10, a moment in a rotation direction R is generated, and an impact energy in the drop direction F can be released in the rotation direction R. That is, in the electronic device 1, the battery pack 10 and the housing 40 are fixed at the two corner portions 10C on the second line L2, and the battery pack 10 and the housing 40 are fixed at the two corner portions 10D on the third line L3, but the adhesive strength of the two corner portions 10D on the third line L3 is lower than that of the corner portions 10C. Therefore, in the electronic device 1, the moment in the rotation direction R is generated around the second line L2 in accordance with the impact of the dropping. As a result, the electronic device 1 can reduce a movement amount of the battery element 20 inside the battery pack 10 in accordance with the dropping, so that it is possible to suppress damage at the time of the dropping of the battery pack 10 in which the battery element 20 is movable, similarly to the embodiment. Furthermore, since the electronic device 1 further includes the second adhesive members 51, the adhesive strength between the battery pack 10 and the housing 40 can be improved.

Note that the modification (1) and modification (2) of the exemplary embodiment may be applied to the electronic device 1 of another modification or combined with each other.

Although the preferred embodiment of the present disclosure have been described in detail with reference to the accompanying drawings, the technical scope of the present disclosure is not limited to such examples. It is obvious that a person having ordinary knowledge in the technical field of the present disclosure can conceive various changes or modifications within the scope of the technical idea described in the claims, and it is naturally understood that these also belong to the technical scope of the present disclosure.

Furthermore, the effects described in the present specification are merely illustrative or exemplary, and are not restrictive. That is, the technique according to the present disclosure can exhibit other effects obvious to those skilled in the art from the description of the present specification together with or instead of the above effects.

In the above embodiment, in the electronic device 1, a case where the second line L2 serving as a reference of the adhesive members 50 is the diagonal line of the battery pack 10 has been described, but the present invention is not limited thereto. For example, in the electronic device 1, the second line L2 may be set to pass through the edge near the corner portions 10C shifted from the corner of the battery pack 10 in a range where the angle formed by the first line L1 and the second line L2 is an acute angle.

In the above embodiment, a case where the battery pack 10 having a rectangular outer shape is used has been described as the electronic device 1, but the present invention is not limited thereto. For example, the electronic device 1 may use a battery pack having a polygonal outer shape, a circular outer shape, or the like. In this case, the electronic device 1 may set the fixing positions P of the adhesive members 50 based on the movable direction M of the battery pack 10.

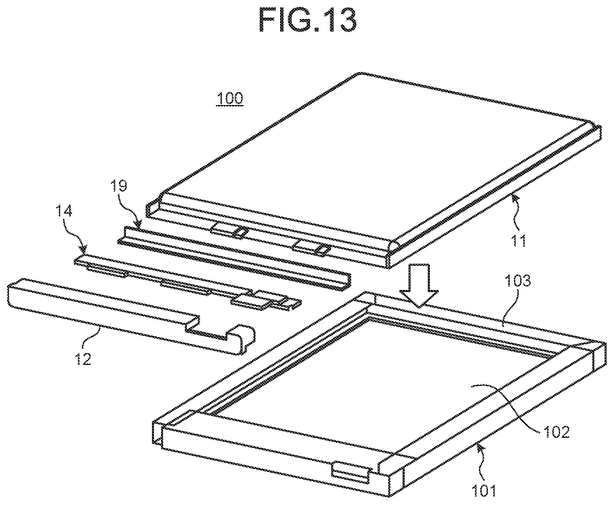

In the above embodiment, a case where the electronic device 1 uses the battery pack 10 has been described, but the configuration of the battery pack is not limited thereto. The electronic device 1 can use battery packs having various different configurations. FIG. 13 is an exploded perspective diagram illustrating another example of the battery pack according to the embodiment. As illustrated in FIG. 13, a battery pack 100 includes a battery cell 11, a top holder 12, a circuit board 14, and a label 101.

The label 101 is formed of a protective member that protects the battery cell 11, the top holder 12, the circuit board 14, and an insulating sheet 19. The label 101 includes a plate-shaped base portion 102 and a frame 103 formed at an edge of the base portion 102. The label 101 fixes the battery cell 11, the top holder 12, the circuit board 14, and the insulating sheet 19 by being attached to the base portion 102. In the present embodiment, the label 101 protects the battery cell 11 in a state where a part of the battery cell 11 is exposed, but the label 101 may be configured to cover the entire battery cell 11.

The battery pack 100 is fixed inside the electronic device 1 similarly to the battery pack 10 described above. However, since the battery element 20 is not fixed to the exterior member 30 inside the battery cell 11, there is a possibility that the battery element 20 moves in the movable direction M due to the impact such as dropping of the electronic device 1, similarly to the battery pack 10.

In the electronic device 1, the battery pack 10 and the housing 40 are bonded by the adhesive members 50 on the second line L2 which is parallel to the movable direction M of the battery pack 100 and at which an angle 0 formed with the first line L1 of the battery pack 10 intersects at an acute angle. As a result, when the electronic device 1 is dropped in the drop direction F along the movable direction M, the impact energy in the battery pack 100 can be suppressed. As a result, the electronic device 1 having the fixing structure according to the embodiment can reduce a movement amount of the battery element 20 inside the battery pack 100 in accordance with the dropping, so that it is possible to suppress damage at the time of the dropping of the battery pack 100 in which the battery element 20 is movable.

In the battery pack 100, for example, various methods can be used as a method of attaching the label 101. In the battery pack 100, for example, a component surrounding the periphery of the battery cell 11 may also serve as a board holder. For example, the battery pack 100 may have a configuration in which an adhesive member such as a tape and a sheet is provided and fixed to four sides or the entire surface of the battery cell 11.

The electronic device 1 may use a built-in battery pack including the battery cell 11 and the circuit board 14 but not including the top holder 12. That is, the electronic device 1 according to the present embodiment can be configured to include built-in battery packs having various configurations that cannot be removed and replaced by the user and may cause the battery element 20 to move due to dropping of the electronic device 1 or the like.

### Effects

The electronic device 1 includes the battery pack 10 having the battery cell 11 housed inside the exterior member 30 so that the battery element 20 is movable in the movable direction M, the housing 40 that houses the battery pack 10, and the adhesive members 50 for bonding the battery pack 10 inside the housing 40. The adhesive members 50 bond the battery pack 10 and the housing 40 on the second line L2 at which the angle θ formed with the first line L1 parallel to the movable direction M is an acute angle and that passes through the center 10S of the battery pack 10.

As a result, when the electronic device 1 is dropped in the movable direction M, a moment in the rotation direction R is generated when the impact due to the dropping is applied to the battery pack 10 via the housing 40, and the impact energy in the drop direction F can be released in the rotation direction R. As a result, the electronic device 1 can reduce a movement amount of the battery element 20 inside the battery pack 10 in accordance with the dropping, so that it is possible to suppress damage at the time of the dropping of the battery pack 10 in which the battery element 20 is movable.

In the electronic device 1, in the battery pack 10, portions (regions) facing the fixing positions P where the adhesive members 50 are bonded to the housing 40 with the first line L1 passing through the center 10S of the battery pack 10 interposed therebetween are not bonded to the housing 40.

As a result, in the electronic device 1, since the battery pack 10 and the housing 40 are not fixed at the portions of the housing 40 facing the fixing positions P with the first line L1 interposed therebetween, it is possible to efficiently generate the moment in the rotation direction R around the second line L2. As a result, the electronic device 1 can further reduce a movement amount of the battery element 20 inside the battery pack 10 in accordance with the dropping, so that it is possible to suppress damage at the time of the dropping of the battery pack 10 in which the battery element 20 is movable.

In the electronic device 1, the adhesive members 50 bond the battery pack 10 and the housing 40 at least two points on the second line L2.

Accordingly, in the electronic device 1, the battery pack 10 and the housing 40 can be bonded to each other at least two points on the second line L2. As a result, the electronic device 1 can suppress damage when the battery pack 10, in which the battery element 20 is movable, is dropped while maintaining the adhesive strength between the battery pack 10 and the housing 40.

In the electronic device 1, the second line L2 is a diagonal line of the battery pack 10 having a polygonal shape, and the adhesive members 50 bond the battery pack 10 and the housing 40 at the corner portions 10C of the battery pack 10 on the second line L2.

As a result, the electronic device 1 can generate the moment in the rotation direction R about the diagonal line of the housing 40 as a moment in accordance with the dropping. As a result, the electronic device 1 can further reduce a movement amount of the battery element 20 inside the battery pack 10 in accordance with the dropping, so that it is possible to suppress damage at the time of the dropping of the battery pack 10 in which the battery element 20 is movable.

In the electronic device 1, the adhesive members 50 are provided in a band shape extending from the corner portions 10C of the battery pack 10 to the vicinity of the first line L1.

Accordingly, in the electronic device 1, by providing the adhesive members 50 in a band shape, the adhesive strength between the battery pack 10 and the housing 40 can be improved. As a result, the electronic device 1 can prevent an installation position of the battery pack 10 from being displaced inside the housing 40 when the slight impact of the housing 40 is applied.

In the electronic device 1, the movable direction M of the battery element 20 in the battery pack 10 is a direction in which the positive electrode terminal 24 and the negative electrode terminal 25 of the battery pack 10 are led out.

As a result, even when the electronic device 1 is dropped in the direction in which the positive electrode terminal 24 and the negative electrode terminal 25 of the battery pack 10 are led out, the moment in the rotation direction R is generated, so that the impact energy transmitted to the positive electrode terminal 24 and the negative electrode terminal 25 of the battery pack 10 can be suppressed. As a result, the electronic device 1 can suppress failure of the battery pack 10, a connection failure with the board, and the like due to dropping.

The electronic device 1 further includes the second adhesive members 51 that bond the battery pack 10 and the housing 40 with a lower adhesive strength than that of the adhesive members 50 at the corner portions (second corner portions) 10D of the battery pack 10 facing the corner portions 10C of the battery pack 10 with the first line L1 interposed therebetween.

As a result, in the electronic device 1, the battery pack 10 and the housing 40 are fixed at the two corner portions 10C on the second line L2, and the battery pack 10 and the housing 40 are fixed at the corner portions (second corner portions) 10D facing the corner portions 10C, but the adhesive strength of the corner portions 10D can be made lower than that of the corner portions 10C. As a result, in the electronic device 1, since the moment in the rotation direction R is generated around the second line L2 in accordance with the impact of dropping, it is possible to suppress damage at the time of dropping the battery pack 10 in which the battery element 20 is movable and to improve the adhesive strength between the battery pack 10 and the housing 40.

Note that the following configurations also belong to the technical scope of the present disclosure.

(1)

An electronic device comprising:

a battery pack that includes a battery cell housed inside an exterior member so that a battery element is movable in a movable direction;

a housing that houses the battery pack; and

adhesive members that bond the battery pack inside the housing,

wherein the adhesive members bond the battery pack and the housing on a second line where an angle formed with a first line parallel to the movable direction is an acute angle and that passes through a center of the battery pack.

(2)

The electronic device according to (1),

wherein in the battery pack, portions facing fixing positions where the adhesive members are bonded to the housing with the first line that passes through the center of the battery pack interposed therebetween are not bonded to the housing.

(3)

The electronic device according to (1) or (2),

wherein the adhesive members bond the battery pack and the housing at least two points on the second line.

(4)

The electronic device according to any one of (1) to (3),

wherein the second line is a diagonal line of the battery pack having a polygonal shape, and

the adhesive members bond the battery pack and the housing at corner portions of the battery pack on the second line.

(5)

The electronic device according to (4),

wherein the adhesive members are provided in a band shape extending from the corner portions of the battery pack to vicinities of the first line.

(6)

The electronic device according to any one of (1) to (5),

wherein the movable direction is a direction in which a terminal of the battery pack is led out.

(7)

The electronic device according to (1), further comprising:

second adhesive members that bond the battery pack and the housing with a lower adhesive strength than that of the adhesive members, at second corner portions of the battery pack facing the corner portions of the battery pack with the first line interposed therebetween.

### REFERENCE SIGNS LIST

1 electronic device

10 battery pack

10C, 10D corner portion

10S center of battery pack

11 battery cell

12 top holder

13 bottom holder

14 circuit board

15 laminate sheet

20 battery element

30 exterior member

40 housing

50 adhesive member

51 second adhesive member

F drop direction

M movable direction

L1 first line

L2 second line

P fixing position

1. An electronic device comprising:
a battery pack that includes a battery cell housed inside an exterior member so that a battery element is movable in a movable direction;
a housing that houses the battery pack; and
adhesive members that bond the battery pack inside the housing,
wherein the adhesive members bond the battery pack and the housing on a second line where an angle formed with a first line parallel to the movable direction is an acute angle and that passes through a center of the battery pack.

2. The electronic device according to claim 1,
wherein in the battery pack, portions facing fixing positions where the adhesive members are bonded to the housing with the first line that passes through the center of the battery pack interposed therebetween are not bonded to the housing.

3. The electronic device according to claim 2,
wherein the adhesive members bond the battery pack and the housing at least two points on the second line.

4. The electronic device according to claim 3,
wherein the second line is a diagonal line of the battery pack having a polygonal shape, and
the adhesive members bond the battery pack and the housing at corner portions of the battery pack on the second line.

5. The electronic device according to claim 4,
wherein the adhesive members are provided in a band shape extending from the corner portions of the battery pack to vicinities of the first line.

6. The electronic device according to claim 1,
wherein the movable direction is a direction in which a terminal of the battery pack is led out.

7. The electronic device according to claim 1, further comprising:
second adhesive members that bond the battery pack and the housing with a lower adhesive strength than that of the adhesive members, at second corner portions of the battery pack facing the corner portions of the battery pack with the first line interposed therebetween
